(19) United States
(12) Patent Application Publication
(10) Pub. No.: US 2009/0000609 A1
(43) Pub. Date: Jan. 1, 2009

(54) Cooking grill with electrically driven variable height fire box

(76) Inventor: William A. Hale, Cottonwood, AZ (US)

Correspondence Address: JAMES RAY & ASSOCIATES, 2640 PITCAIRN ROAD, MONROEVILLE, PA, 15146, US

(21) Appl. No.: 12/214,929

(22) Filed: Jun. 24, 2008

Related U.S. Application Data
(60) Provisional application No. 60/947,174, filed on Jun. 29, 2007.

(51) Int. Cl. A47J 37/00

(52) U.S. Cl. 126/25 R

(57) ABSTRACT

An outside cooking grill has a frame with a cooking box at the upper end thereof. Suspended within the cooking box near the upper end is a grill. The bottom of the cooking box is open and slideably receives therein a vertically moveable firebox. At least one electrically driven jack is mounted on the frame for raising and lowering the firebox to thereby increase or decrease the temperature in the cooking box.

The applicant claims priority from his provisional application filed Jun. 29, 2007 and assigned Ser. No. 60/947,174. The present application relates to outside cooking grills and the like having a fire box for burning charcoal or other combustible and a power operated adjustment for raising or lowering a firebox to thereby adjust cooking temperature.

### BACKGROUND OF THE INVENTION

Outside cooking grills are generally of two types, gas and charcoal. The temperature at which a gas grill burns is easily regulated, but it is generally difficult to adjust the cooking temperature for a charcoal operated grill. When the charcoal is first lit and only a small portion of the charcoal is burning, the temperature may not be great. After a period of time, all of the charcoal in the firebox will become ignited and considerably more heat will be released. When the grill is used to cook steaks or other oil containing food, the excess grease and oil falling into the firebox may further increase cooking temperature. On the other hand, adverse weather, such as wind and rain, might reduce the cooking temperature as will the reduction of the fuel supply as the charcoal is consumed.

One method that is used to control the temperature of a charcoal burning grill is to entirely enclose the firebox with the exception of a plurality of adjustable vents. To enclose the firebox, a cover is provided having an outer rim that seals against the walls of the firebox. The cover, however, limits the chef's ability to monitor the food being cooked and many outdoor chefs prefer cooking without enclosing the firebox. Efforts have been made to provide a mechanical linkage between the legs of the grill and the firebox for raising and lowering the firebox with respect to the cooking grill, but these efforts have been largely unsuccessful for a number of reasons. First, the metal parts are manually adjustable and they become hot and difficult to safely operate. Second, ash and other debris from the firebox can inhibit the operation of the manually operated parts.

It would be desirable, therefore, to provide an improved cooking grill having a vertically adjustable firebox that can be operated safely and dependably even when the parts are hot and the firebox is releasing ash.

### BRIEF DESCRIPTION OF THE INVENTION

Briefly, the present invention is embodied in a cooking grill having a frame having an upper end, a lower end, and spaced apart first and second sides. A horizontal cooking surface such as a grill is provided at the upper end of the frame and a support structure, such as wheels or slides, is provided at the lower end of the frame.

Mounted to the frame below the cooking surface is a first jack and a second jack, with each of the jacks having a base, an upper end, a vertically adjustable linkage, and an electric motor connected to the linkage and a control remote from the motor for controlling the motor and the linkage to raise and lower the upper end of the jacks. Positioned below the grill and extending across the upper ends of the first and second jacks is a firebox for containing a suitable fuel such as charcoal briquettes. By adjusting the controls from a location remote from the grill, the firebox can be safely raised or lowered.

### BRIEF DESCRIPTION OF THE DRAWINGS

A better understanding of the invention will be had after a reading of the following detailed description taken in conjunction with the drawings wherein:

FIG. 1 is a front elevational view of a cooking grill in accordance with the present invention;

FIG. 2 is a side elevational view of the cooking grill shown in FIG. 1;

FIG. 3 is a cross-sectional view of the cooking grill shown in FIG. 1 taken through line 3-3 thereof;

FIG. 4 is a cross-sectional view of the cooking grill shown in FIG. 1 taken through line 4-4 of FIG. 2;

FIG. 5 is cross-sectional view of the cooking grill shown in FIG. 1 taken through line 5-5 of FIG. 1; and

FIG. 6 is yet another cross-sectional view of the grill shown in FIG. 1 taken through line 5-5 thereof.

### DETAILED DESCRIPTION OF A PREFERRED EMBODIMENT

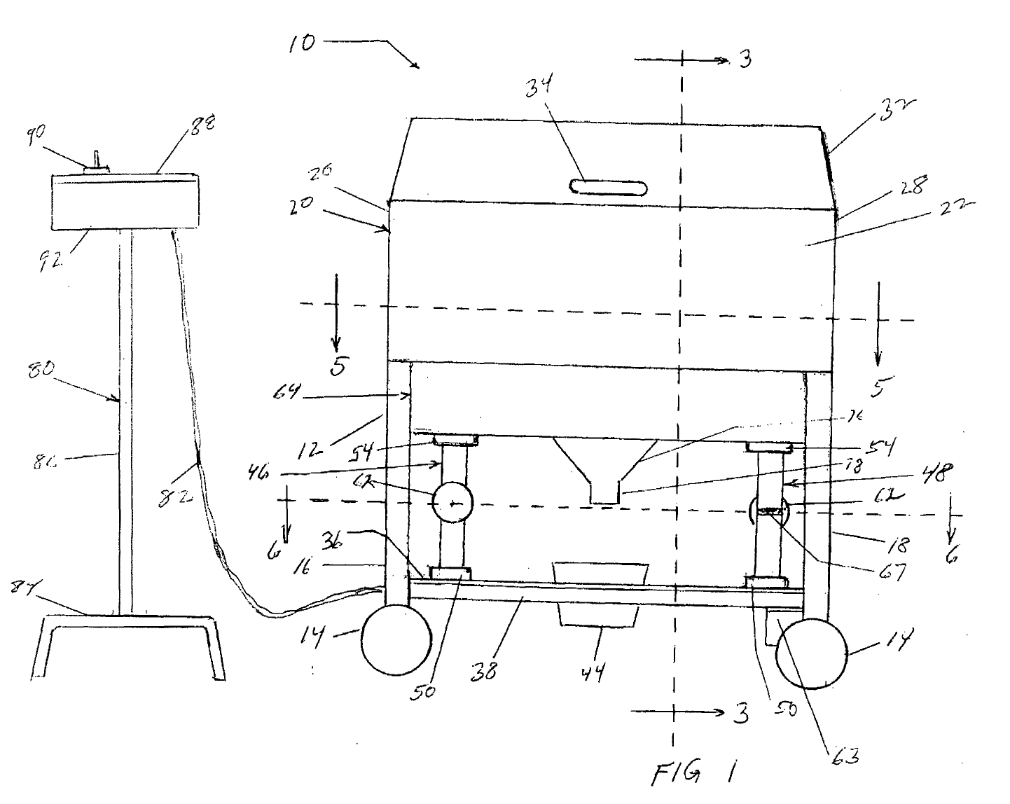

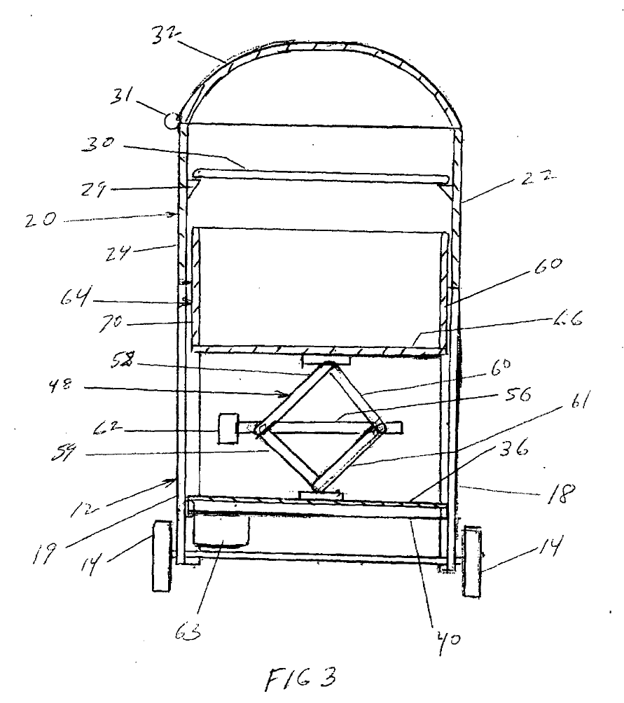

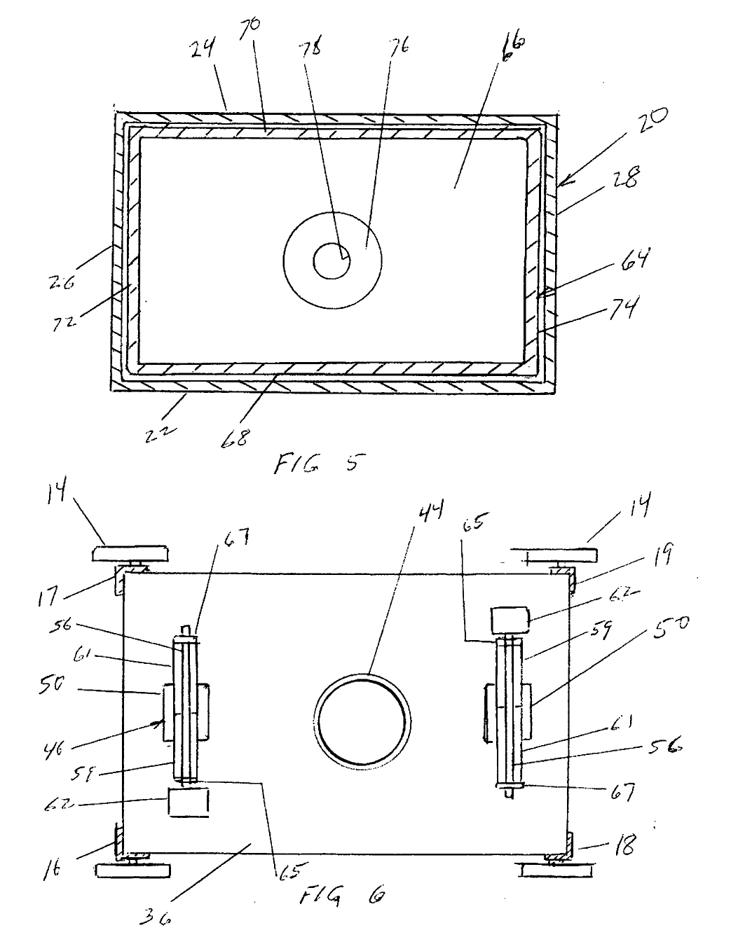

Referring to FIGS. 1 through 6, a cooking grill 10 in accordance with the present invention has a metal frame 12 with a plurality of wheels 14-14 at the lower end thereof, and extending upward of the wheels 14-14 are vertically extending legs 16, 17, 18, 19 at the upper end of which is a generally rectangular cooking box 20. The cooking box 20 has a front panel 22, a back panel 24, and left and right side panels 26, 28 respectively. Extending near the upper end of the various panels 22, 24, 26, 28 and resting on a plurality of supports 29-29 is a horizontal cooking surface such as a removable cooking grill 30. Connected by hinges 31 to the upper edge of the back panel 24 is a domed cover 32 having a handle 34 for opening and closing the cover over the grill 30 as needed. The lower end of the cooking box 20 is open so as to receive the upper end of the firebox described below. Positioned between the legs 16-19 and a short distance above the wheels 14-14 is a generally rectangular horizontal mounting platform 36. The mounting platform 36 is rigidly retained to the legs 16-19 by horizontal side members 38, 39, 40, 41 to thereby provide support to the outer edges of the mounting platform 36.

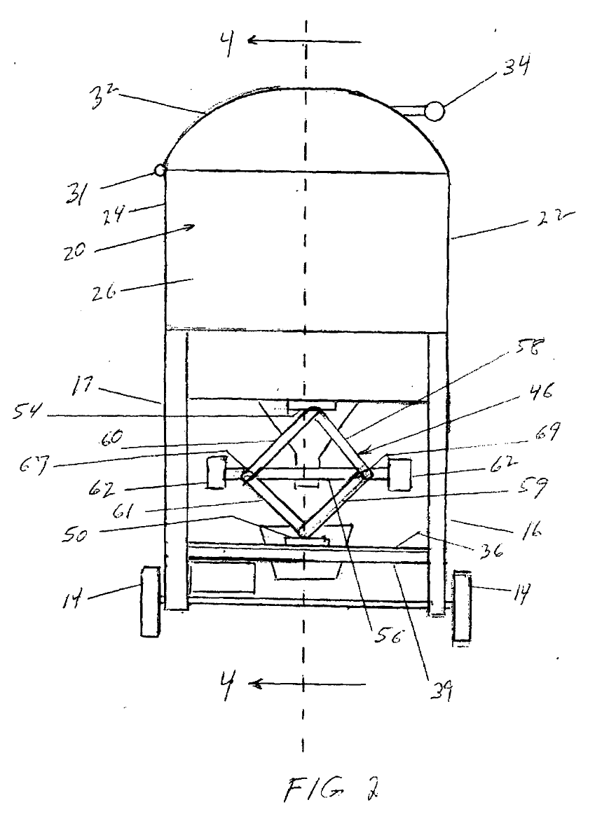

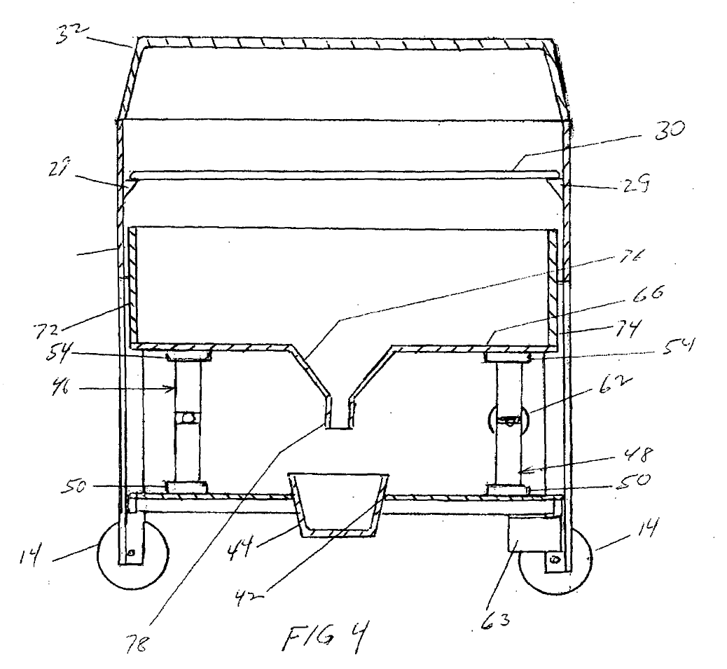

As best shown in FIGS. 4 and 6, the mounting platform 36 has a central opening 42 that removably receives a bucket 44 for accumulating ash and other debris falling from the firebox as is further described below. Positioned near legs 16, 17 on the mounting platform 36 is a first jack 46 and positioned near legs 18, 19 is a second jack 48 that is identical to the first jack 46. As best seen in FIGS. 2 and 4, each of the jacks 46, 48 has a base 50 secured by bolts or the like (not identified) to the mounting platform 36. Above the base 50 is a linkage for vertically raising or lowering an upper end plate 54. In the embodiment depicted, the linkage is in the form of a scissors jack with the upper end plate 54 raised or lowered by rotating a threaded shaft 56 extending between a first pair of hinged together scissor arms 58, 59 and a second pair of hinged together scissor arms 60, 61. The threaded shaft 56 is rotated by a reversible DC electric motor 62 powered by a battery 63 positioned between two of the legs 16, 17 and below the mounting platform 36. When the electric motor 62 is operated in one direction, the threaded shaft 56 draws the hinge 65 of the first pair of scissor arms 58, 59 toward the hinge 67 of the second pair of scissor arms 60, 61 thereby raising the upper end plate 54. When the polarity of power to the electric motor 62 is reversed, the motor 62 and threaded shaft 56 rotate in the opposite direction urging the hinge 65 of the first pair of scissor arms 58, 60 away from the hinge 67 of the second pair of scissor arms 60, 62 and lowering the upper end plate 54.

Mounted on the upper end plates 54 of the first and second jacks 46, 48 is a rectangular firebox 64 having a rectangular floor 66 and extending vertically upward from the sides of the floor 66 a front panel 68, a rear panel 70, and first and second side panels 72, 74. The horizontal dimensions of the outer surfaces of the panels 68, 70, 71, 72 are a little smaller than the complementary dimensions of the inner surfaces of the panels 22, 24, 26, 28 of the cooking box 20 such that the firebox 64 can move vertically within the various panels 22, 24, 26, 28 of the cooking box 20 as the upper end plates 54 of the jacks 46, 48 raise or lower the firebox 64.

The electrically operated jacks 46, 48 are currently commercially available and each of the jacks 46, 48 includes an upper limit switch and a lower limit switch. The upper and lower limit switches of each jack are vertically adjustable to thereby limit the maximum elevation to which the upper plate 54 of the jack 46, 48 can be raised and to limit the lowest level to which the upper plate 54 can be lowered. The upper limit switch for each jack 46, 48 is set to terminate power to the motor 62 when the threaded shaft 56 has driven the firebox 64 to the highest position allowable within the cooking box 20 when the firebox 64 does not interface with the grill 30. Similarly, the lower limit switch for each jack 46, 48 is set to terminate power to the motor 62 when the firebox 64 drops to the lowest elevation desirable with respect to the cooking box 20. The upper limits of both jacks are set at the same elevation and the lower limits of both are set at the same elevation. As a result, any inequality in the operation of the two jacks is removed when the firebox 64 is driven to either its highest or its lowest elevation.

As best seen in FIGS. 2, 4 and 6, centrally located in the floor 66 of the firebox 64 and extending through a hole (unnumbered) in the surface thereof is a downwardly extending funnel 76 through which ash and other debris can fall. The funnel 76 has a narrow neck 78 positioned directly above the bucket 44 in the support station 36. Accordingly, ash from burning charcoal in the firebox 64 can fall through the funnel 76 and be collected in the bucket 44 where it will not interfere with the operation of the jacks 46, 48 and it can be discarded after the cooking process is completed. Also, the provision of a hole in the floor of the firebox allows air to be drawn from below the charcoal fuel and thereby provides for a more complete combustion of the fuel.

Referring further to FIG. 1, separated from the frame 12 of the cooking grill 10 is a free standing control station 80 that is connected to the grill 10 by a cable 82. The cable 82 has a plurality of electric wires therein connected to the electric motors 62 of the first and second jacks 44, 46 and the battery 63.

The control station 80 has a stand 84 and extending upward of the stand 84 is a post 86 at the upper end of which is a horizontal surface 88. The surface 88 has mounted there a double pole double throw switch 90 connected by the electric wires in the cable 82 to the electric motors 62 and the battery 63. The motors 62 of the two jacks 44, 46 are electrically connected for parallel simultaneous synchronized operation by the single switch 90. Actuation of the switch 90 in a first direction connects power to the motor 62 in one polarity to elevate the firebox 64 and actuation of the switch 90 in the opposite direction connects power to the motor 62 in the reverse polarity to lower the firebox 64 as needed to increase or decrease heat to the cooking grill 30. The switch 90 has a standby position midway between the first and second positions wherein the motor 62 is disconnected from the battery 63. The control station 80 further includes a solar panel 92 connected by wires, not shown, through the cable 82 to the battery 63 for recharging the battery during sunny days.

To operate the grill 10 charcoal or other combustible fuel is placed within the firebox 64 and ignited. When the combustion within the firebox 64 is sufficient for cooking, the chef can cook food on the grill 30 and use the handle 34 to cover the cooking food with the domed lid 32 as needed. If the heat generated within the firebox 64 becomes excessive, the chef can use the switch 90 to operate the motor 62 of the jacks 46, 48 to lower the firebox 64 thereby reducing the heat being applied to the grill 30. Conversely, if the flame within the firebox 64 begins to wane, the chef can actuate the switch 90 in the opposite direction causing the jacks 46, 48 to elevate the firebox 64 thereby applying more heat to the grill 30. Since the control station 80 is mounted on a stand 84 that is remote from the grill 10, the chef can operate the switch 90 without exposing his hands to hot surfaces on the frame 12. Also, debris from the firebox 64 will not interfere with the operation of the jacks 46, 48 because it will be channeled through the neck 78 of the funnel 76 into the collection bucket 44.

It should be appreciated that while the control station 80 has been described as connected to the frame 12 by a cable 82, the solar panel 92 could be mounted on the frame 12 or the cover 32 and the control station 80 could be in the form of a hand held wireless transmitter of the type well known in the wireless art that transmits a signal to a receiver on the frame 12. Such a hand held device would not require a stand 84.

While the present invention has been described with respect to a single embodiment, it will be appreciated that many modifications and variations may be had without departing from the spirit and scope of the invention. It is therefore the intent of the following claims to cover all such modifications and variations that fall within the spirit and scope of the invention.

What is claimed:

1. a cooking grill comprising,
a frame having an upper end, a lower end and spaced apart first and second sides,
a support structure at said lower end,
a horizontal cooking surface at said upper end,
a jack having a base, an upper end, a vertically adjustable linkage and an electric motor connected to said linkage for raising and lowering said upper end, said base of said jack on said frame below said cooking surface, and
a firebox mounted on said upper end of said jack.

2. The cooking grill of claim 1 and further comprising
a control for controlling the direction of rotation and application of power to said motor, and
said control remote from said frame.

3. The cooking grill of claim 1 and further comprising
a second jack having a base, and upper end, a vertically adjustable linkage and an electric motor connected to said linkage for raising and lowering said upper end,
said second jack base mounted on said frame below said cooking surface and spaced from said jack base, a single control for controlling said jack motor and said second jack motor for synchronized and simultaneous operation of said motor.

4. The cooking grill of claim 1 and further comprising
a battery,
a switch for connecting said battery to said motor, and
a solar panel connected to said battery for recharging said battery.

5. The cooking grill of claim 2 and further comprising
a battery,
said control connecting and unconnecting said battery to said motor, and
a solar panel connected to said battery for recharging said battery.

6. The cooking grill of claim 5 and further comprising
a vertical stand remote from said frame,
said photoelectric cell on said stand, and
said control on said stand.
